(19) United States
(12) Patent Application Publication
(10) Pub. No.: US 2021/0182656 A1
(43) Pub. Date: Jun. 17, 2021

(54) ARITHMETIC PROCESSING DEVICE

(71) Applicant: OLYMPUS CORPORATION, Tokyo (JP)

(72) Inventor: Hideaki Furukawa, Tokyo (JP)

(73) Assignee: OLYMPUS CORPORATION, Tokyo (JP)

(21) Appl. No.: 17/183,720

(22) Filed: Feb. 24, 2021

Related U.S. Application Data
(63) Continuation of application No. PCT/JP2018/038076, filed on Oct. 12, 2018.

(51) Int. Cl. G06N 3/063; G06F 7/507; G06F 17/15

(52) U.S. Cl. CPC G06N 3/063; G06F 17/15; G06F 7/507

(57) ABSTRACT

In this arithmetic processing device, during a filter processing and a cumulative addition processing for calculating a specific pixel of an output feature amount map, an arithmetic controller controls so as to temporarily store an intermediate result in a cumulative addition result storing memory and process another pixel, store the intermediate result of the cumulative addition processing for all pixels in the cumulative addition result storing memory, then return to a first pixel, read the value stored in the cumulative addition result storing memory as an initial value of the cumulative addition processing, and continue the cumulative addition processing.

### CROSS REFERENCE TO RELATED APPLICATIONS

This application is a continuation application based a PCT Patent Application No. PCT/JP2018/038076, filed on Oct. 12, 2018, the entire content of which is hereby incorporated by reference.

### BACKGROUND

### Technical Field

The present invention relates to a circuit configuration of an arithmetic processing device, more specifically, an arithmetic processing device that performs deep learning using a convolutional neural network.

Background Art

Conventionally, an arithmetic processing device is known that performs arithmetic using a neural network in which a plurality of processing layers are hierarchically connected. In particular, in arithmetic processing devices that perform image recognition, deep learning using a convolutional neural network referred to as CNN) is widely performed.

FIG. 18 is a diagram showing a flow of image recognition processing by deep learning using CNN. In image recognition by deep learning using CNN, the input image data (pixel data) is sequentially processed in a plurality of processing layers of CNN, so that the final calculation result data in which the object included in the image is recognized is obtained.

The processing layer of CNN is roughly classified into a convolution layer and a full-connect layer. The convolution layer performs a convolution processing including convolution calculation processing, non-linear processing, reduction processing (pooling processing), and the like. The full-connect layer performs a full-connect processing in which all inputs (pixel data) are multiplied by the filter coefficient to perform cumulative addition. However, there are also convolutional neural networks that do not have a full-connect layer.

Image recognition by deep learning using CNN is performed as follows. First, image data is subjected to a combination of a convolution calculation processing (combination processing), which generates a feature map (FM) by extracting a certain area and multiplying it by multiple filters with different filter coefficients, and a reduction processing (pooling process), which reduces a part of the feature map, as one processing layer, and this is performed a plurality of times (in a plurality of processing layers). These processes are the processes of the convolution layer.

The pooling processing has variations such as max polling in which the maximum value of the neighborhood 4 pix is extracted and reduced to ½×½, and average polling in which the average value of the neighborhood 4 pix is obtained (not extracted).

FIG. 19 is a diagram showing a flow of convolution processing. First, the input image data is subjected to filter processing having different filter coefficients, and all of them are cumulatively added to obtain data corresponding to one pixel. By performing non-linear conversion and reduction processing (pooling processing) on the generated data and performing the above processing on all pixels of the image data, an output feature map (oFM) is generated for one plane. By repeating this a plurality of times, a plurality of planes of oFM are generated. In an actual circuit, all of the above is subjected to a pipeline processing.

Further, the above-described convolution processing is repeated by using the output feature amount map (oFM) as an input feature amount map (iFM) for next processing to perform filter processing having different filter coefficients. In this way, the convolution processing is performed a plurality of times to obtain an output feature amount map (oFM).

When the convolution processing progresses and the FM is small-sized to a certain extent, the image data is read as a one-dimensional data string. The full-connect processing, in which each data in the one-dimensional data string is multiplied by a different coefficient and cumulatively added, is performed a plurality of times (in a plurality of processing layers). These processes are the processing of the full-connect layer.

Then, after the full-connect processing, the probability that the object included in the image is detected (the probability of subject detection) is output as the subject estimation result as the final calculation result. In the example of FIG. 18, as the final calculation result data, the probability that a dog was detected was 0.01 (1%), the probability that a cat was detected was 0.04 (4%), the probability that a boat was detected was 0.94 (94%), and the probability that a bird was detected was 0.02 (2%).

In this way, image recognition by deep learning using CNN can realize a high recognition rate. However, in order to increase the types of subjects to be detected and to improve the subject detection accuracy, it is necessary to increase the network. Then, the data-storing buffer and the filter coefficient storing buffer inevitably have a large capacity, but the ASIC (Application-Specific Integrated Circuit) cannot be equipped with a very large capacity memory.

Further, in deep learning in image recognition processing, the relationship between the FM (Feature Map) size and the number of FMs (the number of FM planes) in the (K−1) layer and the Kth layer may be as shown in the following equation. In many cases, it is difficult to optimize when determining the memory size as a circuit.

FM size [K]=1/4×FM size [K−1]

FM number [K]=2×FM number [K−1]

For example, when considering the memory size of a circuit that can support Yoro_v2, which is one of the variations of CNN, about 1 GB is required if it is determined only by the FM size and the maximum value of the FM number. Actually, since the number of FMs and the FM size are inversely proportional to each other, a memory of about 3 MB is sufficient for calculation. However, for an ASIC mounted on a battery-powered mobile device, there is a need to reduce power consumption and chip cost as much as possible. Therefore, it is necessary to make the memory as small as possible.

Due to such problems, CNN is generally implemented by software processing using a high-performance PC or GPU (Graphics-Processing Unit). However, in order to realize high-speed processing, it is necessary to configure a heavy-processing part with hardware. An example of such a hardware implementation is described in Japanese Unexamined Patent Application, First Publication No. 2017-151604 (hereinafter referred to as Patent Document 1).

Patent Document 1 discloses an arithmetic processing device in which an arithmetic block and a plurality of memories are mounted in each of a plurality of arithmetic processing parts to improve the efficiency of arithmetic processing. The ;arithmetic, block and the buffer paired with the arithmetic block perform convolution arithmetic processing in parallel via a relay unit, and transmit cumulative addition data between the arithmetic parts. As a result, even if the input, network is large, inputs to the activation process can be generated at once.

The configuration of Patent Document 1 is an asymmetrical configuration baying a hierarchical relationship (having directionality), and the cumulative addition intermediate result passes through all the arithmetic blocks in cascade connection. Therefore, when trying to correspond to a large network, the cumulative addition intermediate result must pass through the relay unit and the redundant data holding unit many times, a long cascade connection path is formed, and processing time is required. Further, when a huge network is finely divided, the amount of access to the DRAM may increase by reading (rereading) the same data or filter coefficient from the DRAM (external memory) a plurality of times. However, Patent Document 1 does not describe a specific control method for avoiding such a possibility and does not consider it.

### SUMMARY

The present invention provides an arithmetic processing device that can avoid the problem in which calculation cannot be performed at once when the filter coefficient is too large to fit in the WBUF or when the number of iFMs is too large to fit in the IBUF.

An arithmetic processing device for deep learning that performs a convolution processing and a full-connect processing includes: a data-storing memory manager having a data-storing memory configured to store input feature amount: map data and a data-storing memory control circuit configured to manage and control the data-storing memory; a filter coefficient storing memory manager having a filter coefficient storing memory configured to store a filter coefficient and a filter coefficient storing memory control circuit configured to manage and control the filter coefficient storing memory; an external memory configured to store the input feature map data and output feature map data; a data input part configured to acquire the input feature amount map data from the external memory; a filter coefficient input part configured to acquire the filter coefficient from the external memory, an arithmetic part with a configuration in which N-dimensional data is input, processed in parallel, and M-dimensional data is output (where N and M are positive numbers greater than 1), configured to acquire the input feature map data from the data-storing memory, acquire the coefficient from the coefficient storing memory, and perform a filter processing, a cumulative addition processing, anon-linear arithmetic processing, and a pooling processing; a data output part configured to convert the M-dimensional data output from the arithmetic part to output as output feature map data to the external storing memory; a cumulative addition result storing memory manager including a cumulative addition result storing memory configured to temporarily record an intermediate result of cumulative addition processing for each pixel of the input feature map; a cumulative addition result storing memory storing part configured to receive valid data, generate an address, and write it to the cumulative addition result storing memory, and a cumulative addition result: storing memory reading part configured to read specified data from the cumulative addition result storing memory and a controller configured to control in the arithmetic processing device, wherein the arithmetic part includes a filter arithmetic part configured to perform a filter arithmetic on the NI-dimensional data in parallel, a first adder configured to cumulatively add arithmetic results of the filter arithmetic part, a second adder configured to cumulatively add cumulative addition results of the first adder in a subsequent stage, a flip-flop configured to hold a cumulative addition result of the second adder, and an arithmetic controller configured to control in the arithmetic part, in a case where, during filter processing and cumulative addition processing to calculate a particular pixel in the output feature map, all input feature map data required for filter processing and cumulative addition processing cannot be stored in the data-storing memory or all filter coefficients required for filter processing and cumulative addition processing cannot be stored in the filter coefficient storing memory, the arithmetic controller controls so as to temporarily store the intermediate result in the cumulative addition result storing memory to perform a processing for another pixel, to return to a processing for a first pixel when the intermediate result of the cumulative addition processing for all pixels is stored in the cumulative addition result storing memory, to read a value stored in the cumulative addition result storing memory as an initial value of the cumulative addition processing, and to perform a continuation of the cumulative addition processing.

The arithmetic controller may control so as to temporarily store the intermediate result in the cumulative addition result storing memory wheal filter processing and cumulative addition processing that can be performed with all filter coefficients stored in the filter coefficient storing memory are completed, and to perform a continuation of the cumulative addition processing when the filter coefficient stored in the filter coefficient storing memory is updated.

The arithmetic controller may control so as to temporarily store the intermediate result in the cumulative addition result storing memory when all filter processing and cumulative addition processing that are capable of being performed on all input feature amount map data that is capable of being input, and to perform a continuation of the cumulative addition processing when the input feature amount map data stored in the data-storing memory is updated.

The cumulative addition result storing memory manager may include a cumulative addition result storing memory reading part configured to read a cumulative addition intermediate result from the cumulative addition result storing, memory and writes it to the external memory, and a cumulative addition result storing memory storing part configured to read the cumulative addition intermediate result from the external memory and stores it in the cumulative addition result storing memory. The arithmetic controller may control so as to read. the intermediate result from the cumulative addition result storing memory to write into the external memory during the filter processing and the cumulative addition processing for calculating a specific pixel of the output feature amount map, and to read the cumulative addition intermediate result written to the external memory from the external memory to write into the cumulative addition result storing memory, and perform a continuation of the cumulative addition processing when the input feature amount map data stored in the data-storing memory or the filter coefficient stored in the filter coefficient storing memory is updated and the cumulative addition processing is continuously performed.

According to the arithmetic processing device of each aspect of the present invention, since the intermediate result of cumulative addition can be temporarily saved in pixel units of iFM size, it is possible to avoid the problem in which calculation cannot be performed at once because all iFM data cannot be stored in IBUF or the filter coefficient cannot be stored in WBUF.

### BRIEF DESCRIPTION OF THE DRAWINGS

FIG. 1 is an image diagram of obtaining an output feature amount map (oFM) from an input feature amount map (iFM) by a convolution processing.

FIG. 2 is an image diagram showing a case where the WBUF (filter coefficient storing memory) for storing the filter coefficient is insufficient in the convolution processing.

FIG. 3 is an image diagram showing an operation when the filter coefficient is updated once in the middle in the convolution processing in the arithmetic processing device according to a first embodiment of the present invention.

FIG. 4 is a block diagram showing an overall configuration of an arithmetic processing device according to the first embodiment of the present invention.

FIG. 5 is a block diagram showing a configuration of an SBUF manager in the arithmetic processing device according to the first embodiment of the present invention.

FIG. 6 is a diagram showing a configuration of an arithmetic part of the arithmetic processing device according to the first embodiment of the present invention.

FIG. 7A is a flowchart showing a flow of control performed by an arithmetic controller in the arithmetic processing device according to the first embodiment of the present invention.

FIG. 7B is a flowchart showing a flow of filter coefficient update control in step S2 of FIG. 7A.

FIG. 8 is an image diagram in which NI data is divided and input to the arithmetic part in a second embodiment of the present invention.

FIG. 9 is an image diagram showing an operation when iFM. data is updated n times in the middle of convolution processing in the arithmetic processing device according to the second embodiment of the present invention..

FIG. 10A is a flowchart showing control performed by an arithmetic controller in an arithmetic processing device according to the second embodiment oldie present invention.

FIG. 10B is a flowchart showing a flow of iFM data update control in step S22 of FIG. 10A.

FIG. 11 is an image diagram of updating iFM data and filter coefficients on the way in the arithmetic processing device according to a third embodiment of the present invention.

FIG. 12A is a flowchart showing control performed by an arithmetic controller in the arithmetic processing device according to the third embodiment of the present invention.

FIG. 12B is a flowchart showing a flow of iFM data update control in step S42 and filter coefficient update control in step S44 of FIG. 12A.

FIG. 13 is a diagram showing a convolution processing image when two SBUFs are prepared for each oFM in a case where one output channel has to generate an oFM number m of 2.

FIG. 14 is a diagram showing an image of convolution processing in an arithmetic, processing device according to a fourth embodiment. of the present invention.

FIG. 15 is a block diagram showing an overall configuration of the arithmetic processing device according to the fourth embodiment of the present invention.

FIG. 16 is a block diagram showing a configuration of an SBUF manager in the arithmetic processing device according to the fourth embodiment of the present invention.

FIG. 17A is a flowchart showing control performed by the arithmetic controller in the arithmetic processing device according to the fourth embodiment of the present invention.

FIG. 17B is a flowchart showing a flow of iFM data update control in step S72 of FIG. 17A.

FIG. 17C is a flowchart showing a flow of filter coefficient update control in step S76 of FIG. 17A.

FIG. 17D is a flowchart showing a flow of SBUF update control in step S74 of FIG. 17A.

FIG. 17E is a flowchart showing a flow of SBUF evacuation control in step S82 of FIG. 17A.

FIG. 18 is a diagram showing a flow of image recognition processing by deep learning using CNN.

FIG. 19 is a diagram showing a flow of convolution processing according to the prior art.

### DETAILED DESCRIPTION OF THE PREFERRED EMBODIMENTS

An embodiment of the present invention will be described with reference to the drawings. First, the background of adopting the configuration of the embodiment of the present invention will be described.

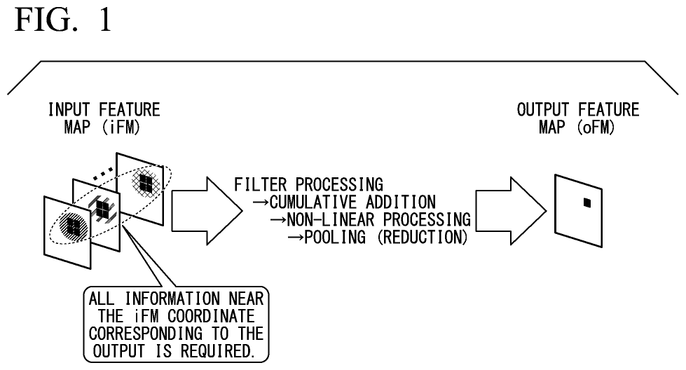

FIG. 1 is an image diagram of obtaining an output feature map (oFM) from a input feature map (iFM) by convolution processing. OFM is obtained by subjecting iFM to processing such as filter processing, cumulative addition, non-linear conversion, and pooling (reduction). As the information required to calculate one pixel of oFM, information (iFM data and filter coefficients) of all pixels in the vicinity of the iFM. coordinates corresponding to the output (1 pixel of oFM) is required.

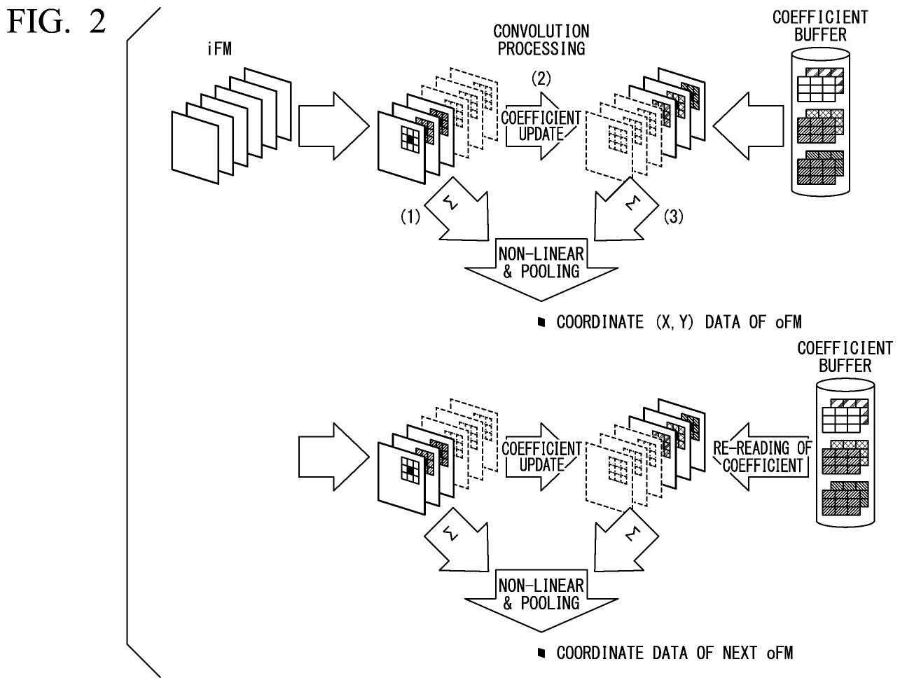

FIG. 2 is an image diagram showing a case where the WBUF (filter coefficient storing, memory) for storing the fiber coefficient is insufficient in the convolution processing. In the example of FIG. 2, from 9 pixel information (iFM data and filter coefficient) in the vicinity of 6 iFM coordinates (X, Y), 1 pixel data (oFM data) of oFM coordinates (X, Y) is calculated. At this time, each iFM data read from the IBUF (data-storing memory) is multiplied by the filter coefficient read from the WBUF (filter coefficient storing memory) to perform cumulative addition.

As shown in FIG. 2, when the size of the WBUF is small, the filter coefficients corresponding to the iFM data cannot be stored in the WBUF. In the example of FIG. 2, the WBUF can store only the filter coefficients corresponding to the three iFM data, in this case, the three iFM data in the first half are multiplied by the corresponding lifter coefficients to perform cumulative addition, and the result (cumulative addition result) is temporarily stored (step 1). Next, the filter coefficients stored in the WBUF are updated (step 2), and the latter three iFMs are multiplied by the corresponding filter coefficients perform cumulative addition (step 3). Then, the cumulative addition result of step 1 and the cumulative addition result of step 3 are added together. After that, non-linear processing and pooling processing are performed to obtain 1-pixel data (oFM data) of oFM coordinates (X, Y).

In this case, when calculating the pixel data (oFM data) of the next coordinate of the oFM, the filter coefficient stored in the WBUF is updated, so that the WBUF needs to read the filter coefficient from the DRAM again. Since the rereading of the filter coefficient is performed for the number of pixels, the DRAM bandwidth is consumed and power is wasted.

### First Embodiment

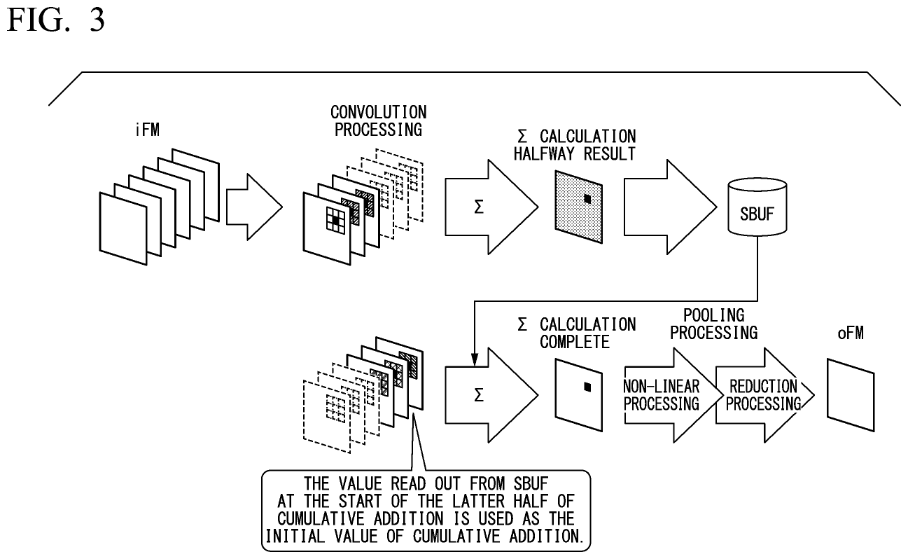

Next, the first embodiment of the present invention will be described with reference to the drawings. FIG. 3 is an image diagram showing an operation when the filter coefficient is updated once in the middle in the convolution processing in the present embodiment. In the convolution processing, all the input iFM data are multiplied by different filter coefficients, and all of them are integrated to calculate 1-pixel data of the oFM (oFM data).

Assuming that the number of iFMs (the number of iFM layers) is N, the number of oFMs (the number of oFM layers) is M, and the filter kernel size is 3×(=9), the total number of elements of the filter coefficient is 9×N×M. N and M vary depending on the network, but can be huge, exceeding tens of millions. In such a case, it is impossible to place a huge WBUF that can store all the filter coefficients, so it is necessary to update the data stored in the WBUF on the way. However, if the size of the WBUF is small enough to not even form one pixel of oFM data (specifically smaller than 9 N), the filter coefficients must be reread in pixel units of oFM, which is very inefficient.

Therefore, in the present embodiment, an SRAM (hereinafter referred to as SBUF (cumulative addition result storing memory)) having the same (or larger) capacity as the iFM size (for one iFM) is prepared. Then, all the cumulative additions that can be performed with the filter coefficients stored in the WBUF are performed, and the intermediate result (cumulative addition result) is written (stored) in the SBUF in pixel units. In the example of FIG. 3, the three iFM data in the first half are multiplied by the corresponding filter coefficients to perform cumulative addition, and the intermediate result is stored in the SBUF. Then, when the filter coefficient stored in the WBUF is updated and the subsequent cumulative addition (cumulative addition of the latter three layers) is started, the value taken out from the SBUF is used as the initial value for cumulative addition, and the latter three iFM data are multiplied by the corresponding filter coefficients to perform cumulative addition. Then, the cumulative addition result is subjected to non-linear processing and pooling processing to obtain 1-pixel data (oFM data) of oFM.

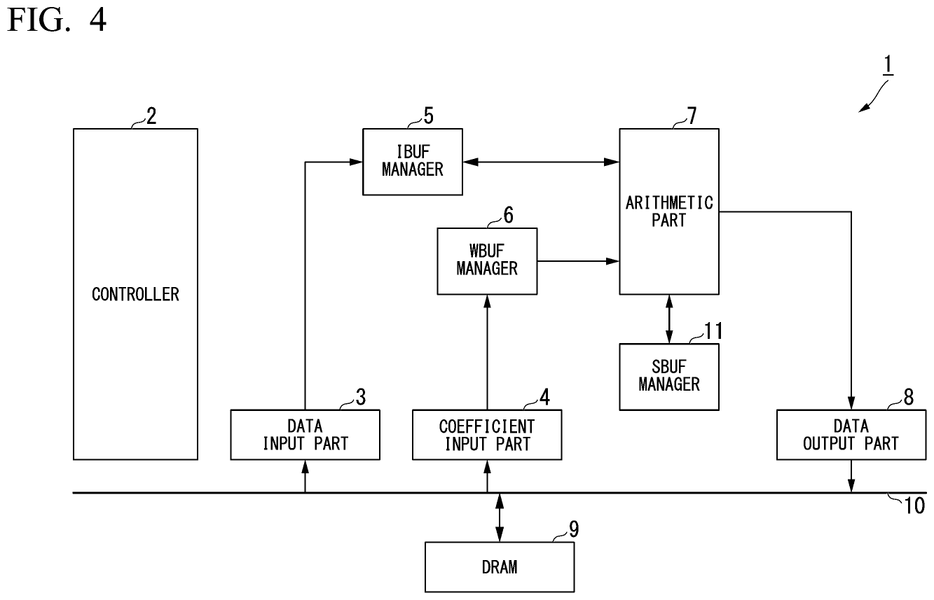

FIG. 4 is a block diagram showing an overall configuration of the arithmetic processing device according to the present embodiment. The arithmetic processing, device 1 includes a controller 2, a data input part 3, a filter coefficient input part 4, an IBUF (data-storing memory) manager 5, a WBUF (filter coefficient storing memory) manager 6, an arithmetic part (arithmetic block) 7, a data output part 8, and an SBUF manager 11. The data input part 3, the filter coefficient input part 4, and the data output part 8 are connected to the DRAM (external memory) 9 via the bus 10. The arithmetic processing device 1 generates fin output feature map (oFM) from the input feature map (iFM).

The IBUF manager 5 has a memory for storing input feature amount map (iFM) data (data-storing memory, IBUF) and a management/control circuit for the data-storing memory (data-storing memory control circuit). Each IBUF is composed of a plurality of SRAMs.

The IBUF manager 5 counts the number of valid data in the input data (iFM data), converts it into coordinates, further converts it into an IBUF address (address in IBUF), stores the data in the data-storing memory, and at the same time, acquires the iFM data from the IBUF by a predetermined method.

The WBUF manager 6 has a memory for storing the filter coefficient (filter coefficient storing memory, WBUF) and a management control circuit for the filter coefficient storing memory (filter coefficient storing memory control circuit). The WBUF manager 6 refers to the status of the IBUF manager 5 and acquires the filter coefficient, which corresponds to the data acquired from the IBUF manager 5. from the WBUF.

The DRAM 9 stores iFM data, oFM data, and filter coefficients. The data input pan 3 acquires an input feature amount map (iFM) from the DRAM 9 by a predetermined method and transmits it to the IBUF (data-storing memory) manager 5. The data output part 8 writes the output feature amount map (oFM) data to the DRAM 9 by a predetermined method. Specifically, the data output part 8 concatenates the M parallel data output from the arithmetic part 7 and outputs the data to the DRAM 9. The filter coefficient input part 4 acquires the filter coefficient from the DRAM 91 by a predetermined method and transmits it to the WBUF (filter coefficient storing memory) manager 6.

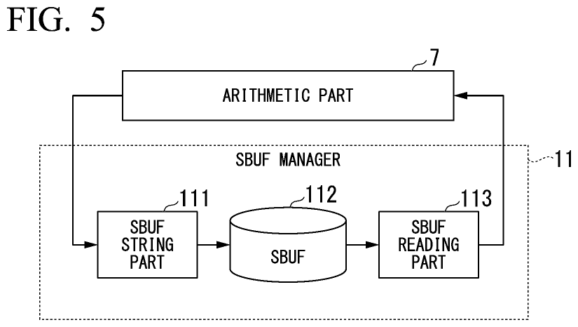

FIG. 5 is a block diagram showing the configuration of the SBUF manager The SBUF manager 11 includes an SBUF storing part 111, an SBUF 112, and an SBUF reading part 113. The SBUF 112 is a buffer for temporarily storing the intermediate result of cumulative addition in each pixel unit of iFM. The SBUF reading part 113 reads desired data (cumulative addition result) from the SBUF 112. When receiving the valid data (cumulative addition result), the SBUF storing part 111 generates an address and writes it to the SBUF 112.

The arithmetic part 7 acquires data from the IBUF (data-storing memory) manager 5 and filter coefficients from the WBUF (filter coefficient storing memory) manager 6. In addition, the arithmetic part 7 acquires the data (cumulative addition result) read from the SBUF 112 by the SBUF reading part 113, and performs data processing such as filter processing, cumulative addition, non-linear calculation, and pooling processing. The data (cumulative addition result) subjected to data processing by the arithmetic part 7 is stored in the SBUF 112 by the SBUF storing part 111. The controller 2 controls the entire circuit.

In CNN, processing for a required number of layers is repeatedly performed in a plurality of processing layers. Then, the arithmetic processing device 1 outputs the subject estimation result as the final output data, and obtains the subject estimation result by processing the final output data using a processor (or a circuit).

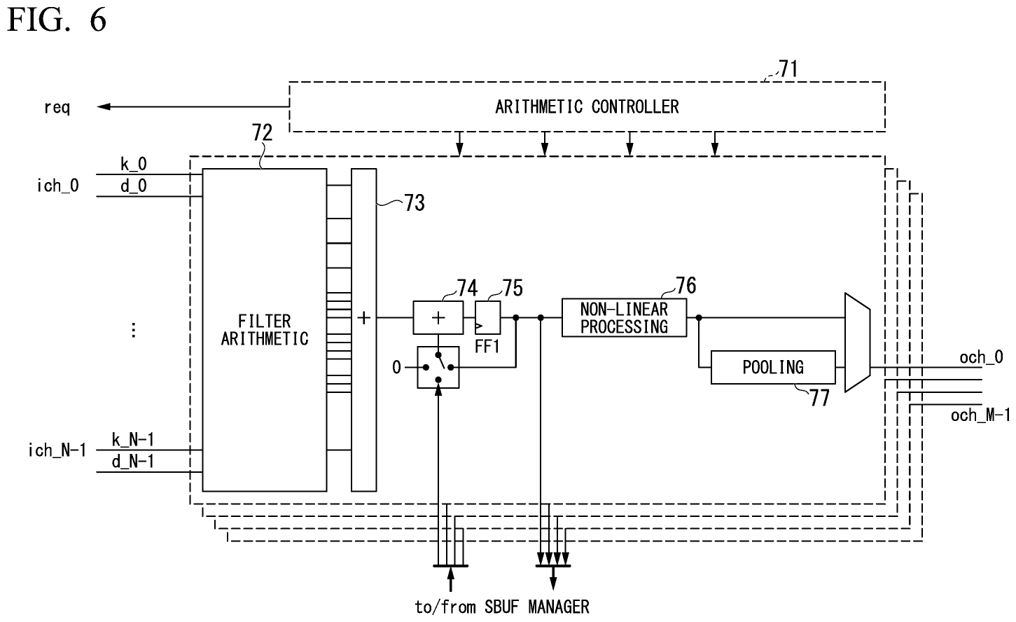

FIG. 6 is a diagram showing a configuration of the arithmetic part 7 of the arithmetic processing device according to the present embodiment. The number of input channels of the arithmetic part 7 is N (N is a positive number of 1 or more), that is, the input data data) is N-dimensional, and the N-dimensional input data is processed in parallel (input N parallel).

The number of output channels of the arithmetic part 7 is M (M is a positive number of 1 or more), that is, the output data is M-dimensional and the M-dimensional input data is output in parallel (output M parallel). As shown in FIG. 6, in one layer, iFM data (d_0 to d_N-1) and filter coefficients (k_0 to k_N-1) are input for each channel (ich_0 to ich_N-1), and one oFM data is output. This process is performed in parallel with the M layer, and M oFM data och_0 to och_M-1 are output.

As described above, the arithmetic part 7 has a configuration in which the number of input channels is N, the number of output channels is M, and the degree of parallelism is N×M. Since the sizes of the number of input channels N and the number of output channels M can be set (changed) according to the size of the CNN, they are appropriately set in consideration of the processing performance and, the circuit scale.

The arithmetic part 7 includes an arithmetic controller 71 that controls each unit in the arithmetic part. Further, the arithmetic part 7 includes a filter arithmetic part 72, a first adder 73, a second adder 74, an FF (flip-flop) 75, a non-linear processing part 76, and a pooling processing part 77 for each layer. Exactly the same circuit exists for each plane, and there are M such layers.

When the arithmetic controller 71 issues a request to the previous stage of the arithmetic part 7, predetermined data is input to the filter arithmetic part 72. The filter arithmetic part 72 is internally configured so that the multiplier and the adder can be operated simultaneously N parallel, performs a filter processing on the input data, and outputs the result of the filter processing in N parallel.

The first adder 73 adds all the results of the filter processing in the filter arithmetic part 72 performed and output in N parallel. That is, the first adder 73 can be said to be a cumulative adder in the spatial direction. The second adder 74 cumulatively adds the calculation results of the first adder 73, which are input in a time-division manner. That is, the second adder 74 can be said to be a cumulative adder in the time direction.

In the present embodiment, there are two cases. In one case, the process is started with the initial value set to zero. In another case, the process is started with the value stored in SBUF 112 as the in initial value. That is, in the switch box 78 shown in FIG. 6, the input of the initial value of the second adder 74 is switched between zero and the value acquired from the SBUF manager 11 (cumulative addition intermediate result).

This switching is performed by the controller 2 based on the phase of cumulative addition currently being performed. Specifically, for each operation (phase), the controller 2 sends an instruction such as a writing destination of the operation result to the arithmetic controller 71, and when the operation is completed, the controller 2 is notified of the end of the operation. At that time, the controller 2 determines from the phase of the cumulative addition that is currently being performed, and sends an instruction to switch the input of the initial value of the second adder 74.

The arithmetic controller 71 performs all the cumulative additions that can be performed by the filter coefficients stored in the WBUF by the second adder 74 and the FF75, and the intermediate result (cumulative addition intermediate result) is written (stored) in the SBUF 112 in pixel units. The FF75 for holding the result of cumulative addition is provided in the subsequent stage of the second adder 74.

The arithmetic controller 71 temporarily stores the intermediate result in the SBUF 112 during the filter processing/cumulative addition processing for calculating the data (oFM data) of a specific pixel of the oFM, and controls to perform processing of another pixel of the oFM. Then, when the arithmetic controller 71 completes storing the cumulative addition intermediate result for all the pixels in the SBUF 112, the arithmetic controller 71 returns to the first pixel, reads the value stored in the SBUF 112, sets it as the initial value of the cumulative addition processing, and controls to perform the continuation of cumulative addition.

In the present embodiment, the timing of storing the cumulative addition intermediate result in the SBUF 112 is the time when the filter cumulative addition processing that can be performed by all the filter coefficients stored in the WBUF is completed, and controls tea continue the process when the filter coefficient stored in the WBUF is updated.

The non-linear processing part 76 performs non-linear arithmetic processing by Activate function or the like on the result of cumulative addition in the second adder 74 and FF75. The specific implementation is not specified, but for example, nonlinear arithmetic processing is performed by polygonal line approximation.

The pooling processing part 77 performs pooling processing such as selecting and outputting (Max Pooling) the maximum value from a plurality of data input from the non-linear processing part 76, calculating the average value (Average Pooling), and the like. The processing in the non-linear processing part 76 and the pooling processing part 77 can be omitted by the arithmetic controller 71.

With such a configuration, the magnitudes of the number of input channels N and the number of output channels M can be set (changed.) in the arithmetic part 7 according to the site of the CNN, so the processing performance and the circuit scale are taken into consideration to set them appropriately. Further, since N parallel processing has no hierarchical relationship, the cumulative addition is a tournament type, a long path such as a cascade connection does not occur, and the latency is short.

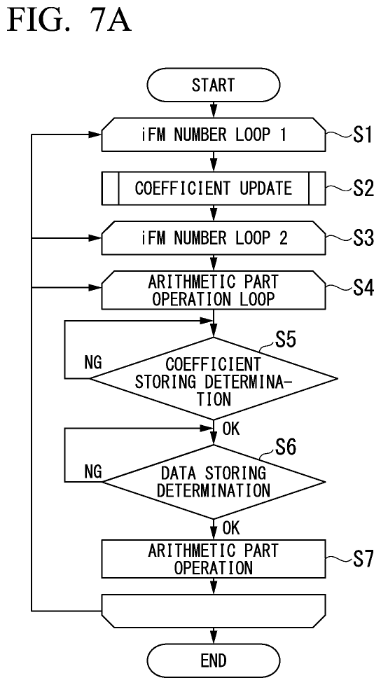

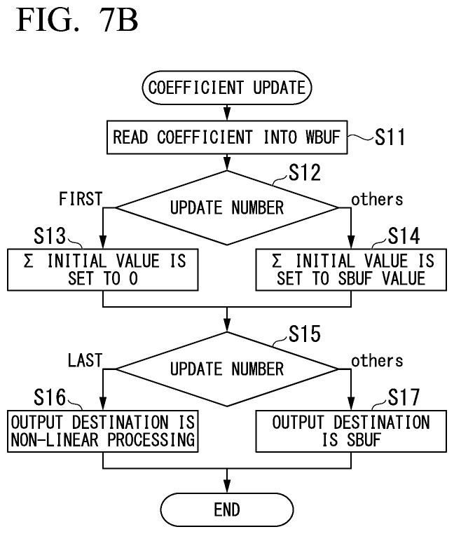

FIG. 7A is a flowchart showing a flow of control performed by the ,arithmetic, controller in the arithmetic, processing device according to the present embodiment, When the convolution processing is started, first, the process proceeds to the “iFM number loop 1” (step S1). Then, the filter coefficient stored in the WBUF is updated (step S2). Next, the process proceeds to the “iFM number loop 2” (step S3).

Next, the process proceeds to the “arithmetic part operation loop” (step S4). Then, “coefficient storing determination” is performed (step S5). In the “coefficient storing determination”, it is determined whether or not the filter coefficient stored in the WBUF is desired. If the result of the “coefficient storing determination” is OK, the process proceeds to the “data-storing determination” (step S6). If the result of the “coefficient storing determination” is not OK, the process waits until the result the “coefficient storing determination” is OK.

In the “data-storing determination” of step S6, it is determined whether or not the iFM data stored in the IBUF is desired. tithe result of the “data-storing, determination” is OK, the process proceeds to the “arithmetic part operation” (step S7). if the result of the “data-storing determination” is not OK, the process waits the “data-storing determination” is OK.

In the “arithmetic part operation” of step S7, the arithmetic part performs the filter cumulative addition processing. When the filter/cumulative addition processing that can be performed with all the filter coefficients stored in the WBUF is completed, the flow ends. When not, the process returns to steps S1, S3, and S4, and the process is repeated.

In a case where the number of iFM data is n₁×n₂×N and the number of “iFM number loop 1” (step S1) is set to n₁ and the number of “iFM number loop 2” (step S3) is set to n₂, the cumulative addition by the second adder 74 is n₂ times, and the number of times to write to the SBUF 112 as an intermediate result is n₁ times.

FIG. 7B is a flowchart showing the flow of filter coefficient update control in step S2 of FIG. 7A. First, in step S11, the filter coefficient is read into WBUF. Then, in step S12, the number of times when the filter coefficient is updated is counted. When the fiber coefficient update is the first, the process proceeds to step S13, and the cumulative addition initial value is set to zero. When the filter coefficient update is not the first, the process proceeds to step S14, and the cumulative addition initial value is set to the value stored in the SBUF.

Next, in step S15, the number of times when the filter coefficient is updated is counted. When the filter coefficient update is the last, the process proceeds to step S16, and the output destination of the data (cumulative addition result) is set to the non-linear processing part. When the filter coefficient update is not the last, the process proceeds to step S17, and the output destination of the data (cumulative addition result) is set to SBUF.

In the filter coefficient update control, the cumulative addition initial value (step S13 or S14) and the output destination (step S16 or S17) of the data (cumulative addition result) are transmitted to the arithmetic controller of the arithmetic part as status information, and the arithmetic controller controls switching of each unit according to its status.

### Second Embodiment

The first embodiment of the present invention deals with the case where the filter coefficient is large (when the WBUF is small), but the same problem occurs even when the iFM data is too large instead of the filter coefficient. That is, consider a case where only a part of iFM data can be stored in IBUF. At this time, if the iFM data stored in the IBUF is updated in the middle in order to calculate the data (oFM data) of one pixel of the oFM, it is necessary to reread the iFM data in order to calculate the data (oFM data) of the next pixel of the oFM, it is necessary to reread the iFM data.

The iFM data required for processing one pixel of the oFM is only the neighborhood information of the same pixel. However, even in a case where only the local area is stored in the IBUF, if the network becomes huge and requires thousands of iFM data, or if the IBUF is reduced to the limit for scale reduction, the data buffer (IBUF) is insufficient, and it is inevitable that the iFM data is divided and read.

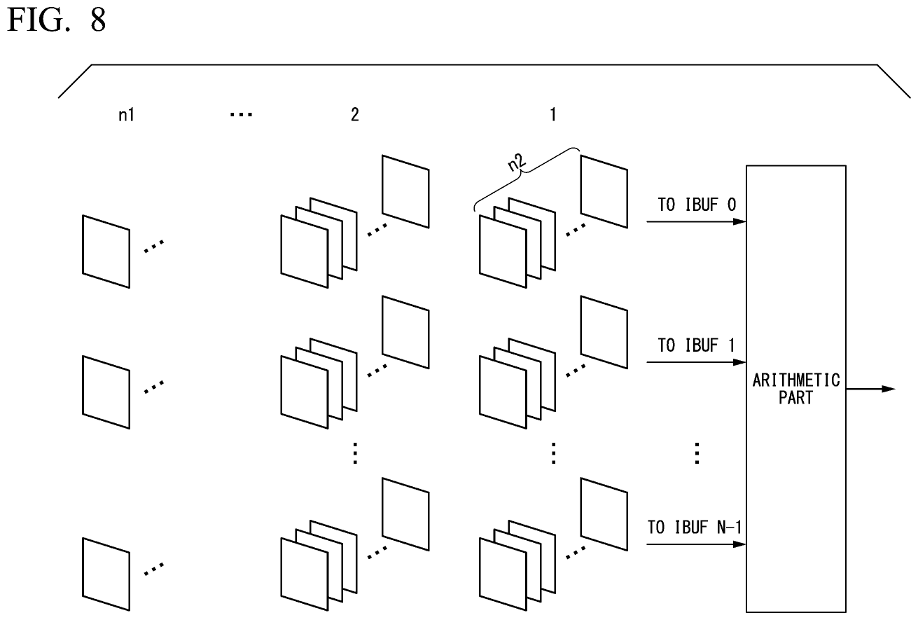

Therefore, in the second embodiment of the present invention, it is possible to deal with the ease where there is too much iFM data (the case where the IBUF is small). The SBUF is provided as in the first embodiment. FIG. 8 is an image diagram in which iFM data is divided and input to the arithmetic part in the present embodiment.

First, iFM data is stored in the n₂×N-plane data buffer (IBUF_0 to IBUF_N-1). Cumulative addition by the second adder 74 (cumulative adder in the time direction) is performed m times in the arithmetic part, and the intermediate result (cumulative addition intermediate result) is written to the SBUF 112. After writing the intermediate results for all pixels, the next iFM data is read on the n₂×N plane, the cumulative addition intermediate results are taken out from the SBUF 112 as initial values, and the cumulative addition operation is continued. By repeating this n₁ times, the n×N (=n₁×n₂×N) plane can be processed.

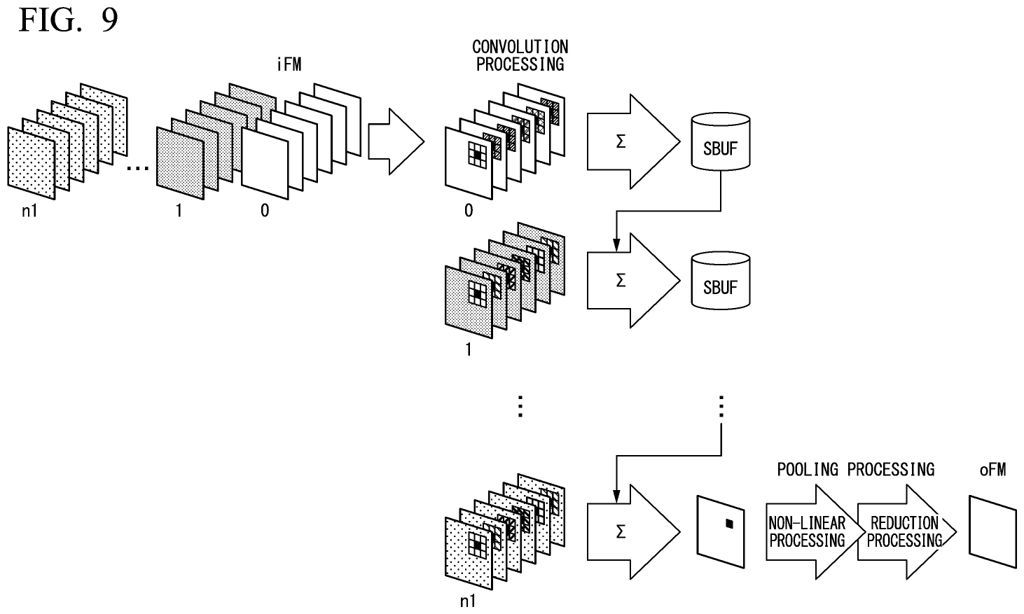

FIG. 9 is an image diagram showing an operation when the iFM data is updated m times in the middle in the convolution processing in the present embodiment, First, each data of the first iFM group (iFM_0) is multiplied by a filter coefficient to perform cumulative addition, and the intermediate result (cumulative addition intermediate result) is written to the SBUF 112. Then, all the calculations that can be performed using the first iFM group (iFM_0) are performed.

Next, the second iFM group (iFM_1) is read into the IBUF. Then, the cumulative addition intermediate result is taken out from the SBUF 112 as an initial value, and each data of the second iFM group (iFM_1) is multiplied by a filter coefficient to perform cumulative addition, and the intermediate result (cumulative addition intermediate result) is written to the SBUF 112. Then, all the calculations that can be performed using the second iFM group (iFM_1) are performed.

The same operation is repeated up to the n₁-st iFM group (iFM_n₁), and the obtained cumulative addition result is subjected to pooling processing such as non-linear processing and reduction processing to obtain data (oFM data) of 1 pixel of oFM. In this way, all the calculations up to the point where it can be done is performed as in the first embodiment.

Since the configuration for performing this embodiment is the same as the configuration for the first embodiment shown in FIGS. 4 to 6, the description thereof will be omitted. The difference from the first embodiment is that the second adder 74 performs all the cumulative additions that can be performed with the iFM data stored in the MI5, and the intermediate result (cumulative addition intermediate result) is written (stored) in the SBUF 112 in pixel units.

Further, in the present embodiment, the timing of storing the cumulative addition intermediate result in the SBUF 112 is when all the falters/cumulative addition processing that can be performed with the inputtable iFM data are completed, and the process is controlled to be continued when the iFM data is updated.

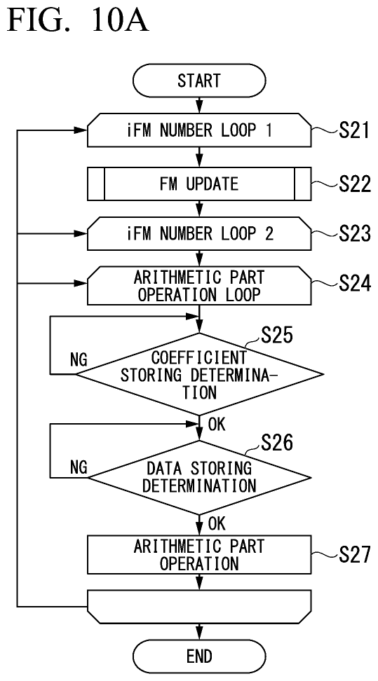

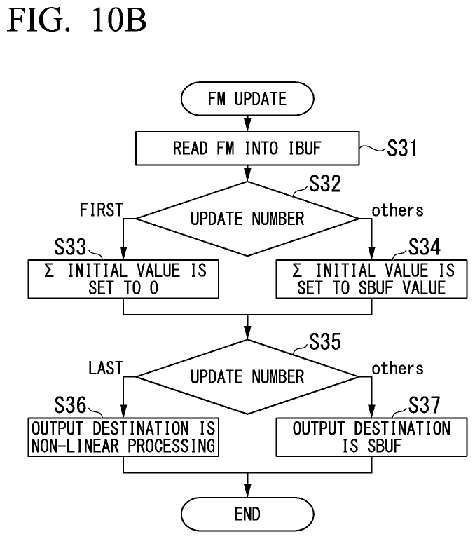

FIG. 10A is a flowchart showing the control performed by the arithmetic controller in the arithmetic processing device according to the present embodiment. When the convolution processing is started, first the process proceeds to the “iFM number loop 1” (step S21). Then, the data stored in the IBUF is updated (step S22). Next, the process proceeds to the “iFM number loop 2” (step S23).

Next, the process proceeds to the “arithmetic part operation loop” (step S24), Then, “coefficient storing determination” is performed (step S25). In the “coefficient storing determination”, it is determined whether or not the filter coefficient stored in the WBUF is desired. When the result of the “coefficient storing determination” is OK, the process proceeds to the “data-storing determination” (step S26). When the result of the “coefficient storing determination” is not OK, the process waits until the result of the “coefficient storing determination” is OK.

In the “data-storing determination” of step S26, it is determined whether or not the iFM data stored in the IBUF is desired. When the result of the “data-storing determination” is OK, the process proceeds to the “arithmetic part operation” (step S27). When the result of the “data-storing determination” is not OK, the process waits until the result of the “data-storing determination” is OK.

In the “arithmetic pan operation” of step S27, the arithmetic part performs the filter/cumulative addition processing. The flow ends when the filter/cumulative addition processing that can be performed on all Flat data stored in the IBUF is completed. When not, the process returns to steps S21, S23, and S24, and the process is repeated.

FIG. 10B is a flowchart showing the flow of iFM data update control in step S22 of FIG. 10A. First, in step S31, iFM data is read into the IBUF. Then, in step S32, the number of times when the iFM data is updated is counted. When the iFM data update is the first, the process proceeds to step S33, and the cumulative addition initial value is set to zero. When the iFM data update is not the first, the process proceeds to step S34, and the cumulative addition initial value is set to the value stored in the SBUF.

Next, in step S35, the number of times when the iFM data is updated is counted. When the iFM data update is the last, the process proceeds to step S36, and the output destination of the data (cumulative addition result) is set to the non-linear processing part. When the iFM data update is not the last, the process proceeds to step S37, and the output destination of the data (cumulative addition result) is set to the SBUF.

In the iFM data update control, the cumulative addition initial value (step S33 or S34) and the output destination (step S36 or S37) of the data (cumulative addition result) are transmitted to the arithmetic controller of the arithmetic part as status information, and the arithmetic controller controls switching of each unit according to its status.

### Third Embodiment

The first embodiment is a case where all the filter coefficients cannot be stored in the WBUF, and the second embodiment is a case where all the iFM data cannot be stored in the IBUF, but there are cases where both occur at the same time. That is, as a third embodiment, a case where all the filter coefficients cannot be stored in the WBUF and all the iFM data cannot be stored in the IBUF will be described.

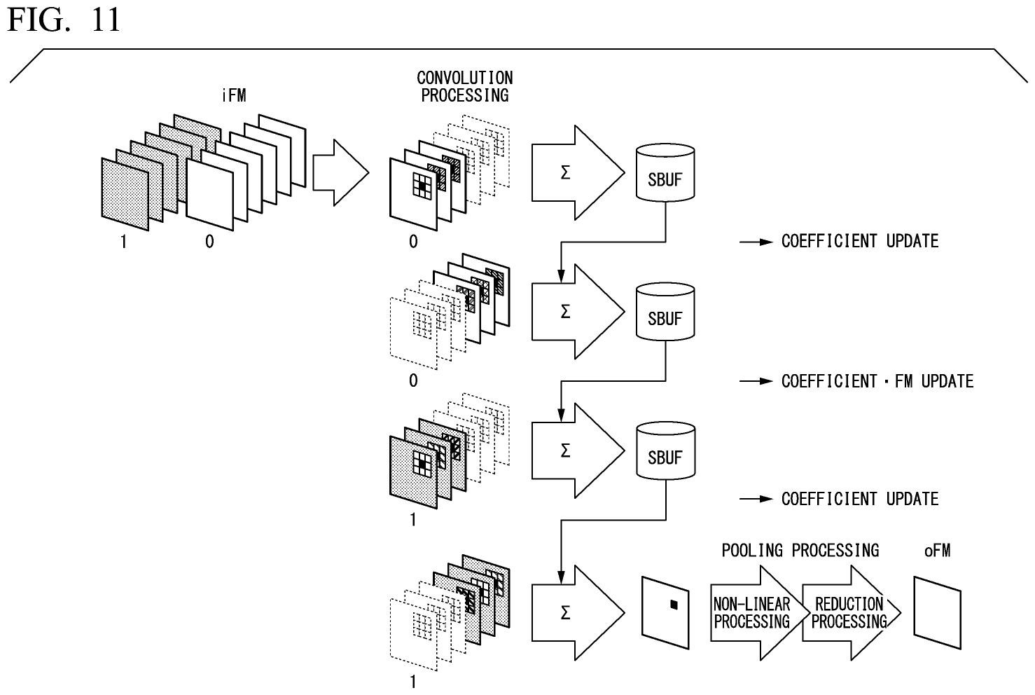

FIG. 11 is an image diagram in which the iFM data and the filter coefficient are updated. in the middle in the present embodiment. FIG. 11 shows an example in which the number of iFM groups n₁ is 2 and the filter coefficient is updated once.

First, each data of the first iFM group (iFM_0) is multiplied by a filter coefficient to perform cumulative addition, and the intermediate result (cumulative addition intermediate result) is written to the SBUF 112.

Next, the filter coefficient group stored in the WBUF is updated. Then, the cumulative addition intermediate result is taken out from the SBUF 112 as an initial value, each data of the iFM group (iFM_0) is multiplied by a filter coefficient to perform cumulative addition, and the intermediate result (cumulative addition intermediate result) is written to the SBUF 112. In this way, all calculations that can be done using the first iFM group (iFM_0) are performed.

Next, the iFM group stored in the IBUF is updated (the second iFM group (iFM_1) is read into the IBUF), and the filter coefficient group stored in the WBUF is updated. Then, the cumulative addition intermediate result is taken out from the SBUF 112 as an initial value, and each data of the second iFM group (iFM_1) is multiplied by a filter coefficient to perform cumulative addition, and the intermediate result (cumulative addition intermediate result) is written to the SBUF 112.

Next, the filter coefficient stored in the WBUF is updated. Then, the cumulative addition intermediate result is taken out front the SBUF 112 as an initial value, and each data of the second iFM group (iFM_1) is multiplied by a filter coefficient to perform Cumulative addition, and the intermediate result (cumulative addition intermediate result) written to the SBUF 112. In this way, all calculations that can be performed using the second iFM group (iFM_1) are performed.

By performing pooling processing such as non-linear processing and reduction processing on the cumulative addition result obtained in this way, data (oFM data) of 1 pixel of OFM can be obtained. In this way, all calculations are performed. up to the point where it can be performed as in the first embodiment and the second embodiment.

As described above, in this embodiment, it is possible to cope with the case where both WBUF and IBUF are insufficient.

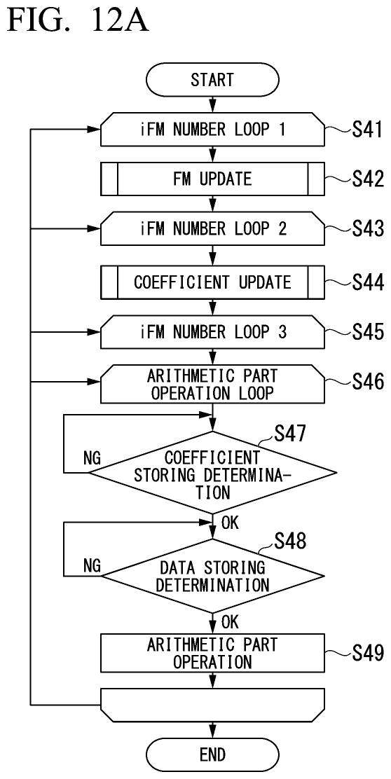

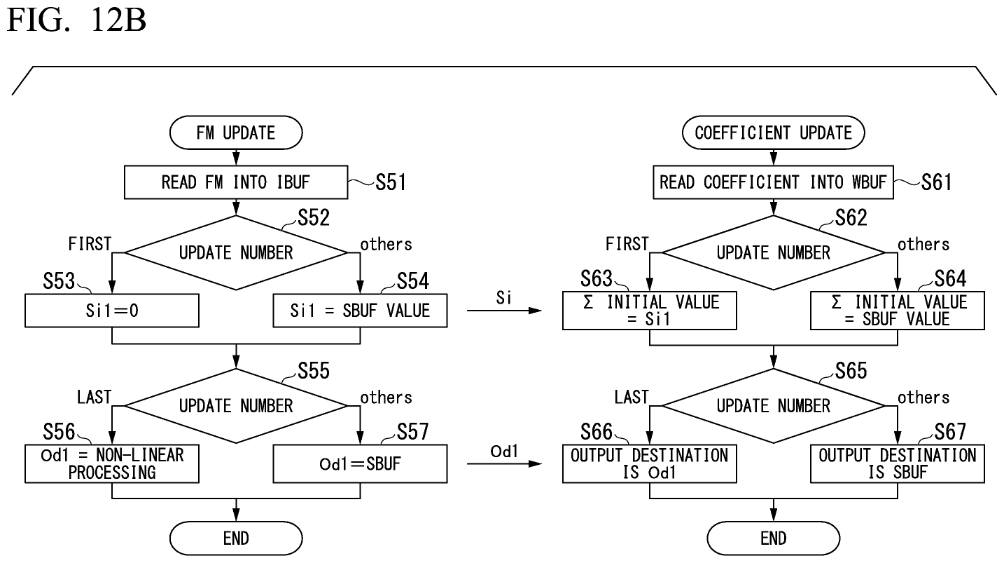

FIG. 12A is a flowchart showing the control performed by the arithmetic controller in the arithmetic processing device according to the present embodiment. FIG. 12A shows an example in which the update frequency of the filter coefficient group is higher than the update frequency of the iFM data. The one with the highest update frequency becomes the inner loop.

When the convolution processing is started, first, the process proceeds to the “iFM number loop 1” (step S41). Then, the iFM data stored in the IBUF is updated (step S42). Next, the process proceeds to the “iFM number loop 2” (step S43). Then, the filter coefficient stored in the WBUF is updated (step S44). Next, the process proceeds to the “iFM number loop 3” (step S45).

Next, the process proceeds to the “arithmetic part operation loop” (step S46). Then, “coefficient storing determination” is performed (step S47). In the “coefficient storing determination”, it is determined whether or not the filter coefficient stored in the WBUF is desired. When the result of the “coefficient storing determination” is OK, the process proceeds to the “data-storing determination” (step S48). When the result of the “coefficient storing determination” is not OK, the process waits until the result of the “coefficient storing determination” is OK.

In the “data-storing determination” of step S48, it is determined whether or not the iFM data stored in the IBUF is desired. When the result of the “data-storing determination” is OK, the process proceeds to the “arithmetic part operation” (step S49), When the result of the “data-storing determination” is not OK, the process waits until the result of the “data-storing determination” is OK.

In the “arithmetic part operation” in step S49, the arithmetic part performs the filter cumulative addition processing. The flow ends when the filter/cumulative addition processing that can be performed on all iFM data stored in the IBUF is completed. When not, the process returns to steps S41, S43, and S46, and the process is repeated.

FIG. 12B is a flowchart showing the flow of the iFM data update control in step S42 and the filter coefficient update control in step S44 of FIG. 12A.

First, update control of iFM data, which is an outer loop, is performed. In step S51, iFM data is read into the IBUF. Then, in step S52, the number of times when the iFM data is updated is counted. When the iFM data update is the first, the process proceeds to step S53, and the value Si1 is set to zero. When the iFM data update is not the first, the process proceeds to step S54, and the value Si1 is set to the value stored in the SBUF.

Then, in step S55, the number of times when the iFM data is updated is counted. When the iFM data update is the last, the process proceeds to step S56, and Od1 is set to the non-linear processing part. When the iFM data update is not the last, the process proceeds to step S57, and Od1 is set to the SBUF.

Next, the update control of the filter coefficient, which is the inner loop, is performed. In step S61, the filter coefficient is read into the WBUF. Then, in step S62, the number of times when the filter coefficient is updated is counted. When the lifter coefficient update is the first, the process proceeds to step S63, and the cumulative addition initial value is set to the value Si1. When the filter coefficient update is not the first, the process proceeds to step S64, and the cumulative addition initial value is set to the value stored in the SBUF.

Then, in step S65, the number of times when the filter coefficient is updated is counted. When the filter coefficient update is the last, the process proceeds to step S66, and the output destination of the data (cumulative addition result) is set to Od1. When the filter coefficient update is not the last, the process proceeds to step S67, and the output destination of the data (cumulative addition result) is set to the SBUF.

In the iFM data update control and filter coefficient control, the output destinations of the values Si1 (step S53 or 554), Od1 (step S56 or 557), the cumulative addition initial value (step S63 or S64), and the output destination (step S66 or S67) of the data (cumulative addition result) are transmitted to the arithmetic controller of the arithmetic part as status information, and the arithmetic controller controls switching of each unit according to the status,

In the above-described control flow, the number of loops is set to n, which is divided as n=n₁×n₂×n₃. Here, the number of times of “iFM number loop 1” (step S41)=n₁, the number of times of “iFM number loop 2” (step S43) and the number of times of “iFM number loop 3” (step S45)=n₃. At this time, the cumulative addition by the second adder 74 is n times, and the number of times when the intermediate result is once written to the SBUF is n₁×n₂ times.

As described above, in the first to third embodiments, with a configuration that enables high-speed processing corresponding to moving images and allows the CNN filter size to be changed, in a configuration that can easily support both convolution processing and full-connect processing, in a circuit with input N parallel and output M parallel, specific control corresponding to the case where iFM number>N and oFM number>M is described, and the method corresponding to the case where the number of iFMs and the number of parameters increases as N and M increase and divided input is required is shown. That is, the above can cope with the case where the CNN network expands.

### Fourth Embodiment

A case where a plurality of oFMs are output from one output channel and the number of oFMs requires a number of planes exceeding the output parallel degree NI is considered. In the process shown in FIG. 11, both the filter coefficient and the are updated during this process to generate one oFM data. In this process, assuming that the number of oFMs that one output channel must generate is m (m>1), a method of repeating, the process shown in FIG. 11 m times can be considered.

In this method, since the MUT is sequentially rewritten, it becomes necessary to reread all the m times. Therefore, the amount of DRAM access increases, and the desired performance cannot be obtained. Therefore, if a plurality of SBUFs are prepared for each OFM, the SBUF can store all the cumulative addition results for m planes and prevent rereading, but the circuit scale increases.

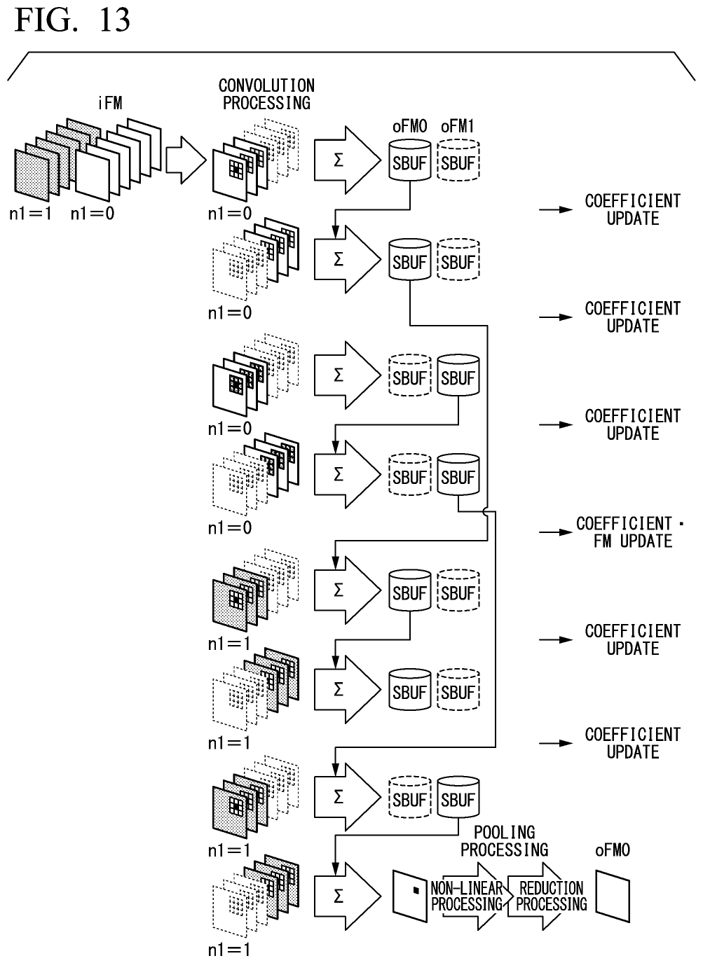

As such an example, FIG. 13 is a diagram showing a convolution processing image when two SBUFs are prepared for each oFM in the case where the number m of oFMs that one output channel has to generate is 2. Since two of oFM data (oFM0 and oFM1) are generated, a first SBUF for storing the cumulative addition result of oFM0 and a second SBUF for storing the cumulative addition result of oFM1 are required to prevent rereading.

First, for oFM0 data, each data of the first iFM group (n₁=0) is multiplied by a filter coefficient to perform cumulative addition, and the cumulative addition intermediate result is stored in the first SBUF. Then, after updating the filter coefficient stored iii the WBUF, the cumulative addition is performed with the value of the first SBUF as the initial value, and the result during; the cumulative addition is stored in the first SBUF.

Next, after updating the filter coefficient stored in the WBUF for oFM1 data, each data of the first iFM group (n₁=0) is multiplied by the filter coefficient to perform cumulative addition, and the cumulative addition intermediate result is stored in the second SBUF Then, after updating the filter coefficient stored in the WBUF cumulative addition is performed with the value of the second SBUF as the initial value, and the cumulative addition intermediate result is stored in the second SBUF.

Next, the second iFM group (n₁=1) is read into a IBUF. Then, for the oFM0 data, the value of the first SBUF is used as the initial value, and each data of the second iFM group (n₁=1) is multiplied by a filter coefficient to perform cumulative addition, and the cumulative addition intermediate result is stored in the first SBUF. Then, after updating the filter coefficient stored in the WBUF, the cumulative addition is performed with the value of the first SBUF as the initial value, and the result during the cumulative addition is stored in the first SBUF.

Next, after updating the filter coefficient: stored in the WBUF for the oFM1 data, each data of the second iFM group (n₁=1) is multiplied by the filter coefficient to perform cumulative addition with the value of the second SBUF as the initial value, and the cumulative addition intermediate result is stored in the second SBUF. Then, after updating the filter coefficient stored in the WBUF, cumulative addition is performed with the value of the second SBUF as the initial value, and the cumulative addition intermediate result is stored in the second SBUF.

The cumulative addition results (that is, finally, the values stored in the first and second SBUFs) obtained in this way are subjected to pooling processing such as non-linear processing and reduction processing, and data of two oFMs are obtained.

As described above, when the number of oFMs requires the number of planes exceeding the output parallelism degree M, in order to prevent rereading, it is necessary to provide as many SBUFs as the number of oFM faces output by one output channel. As a result, SRAM increases and the circuit scale increases.

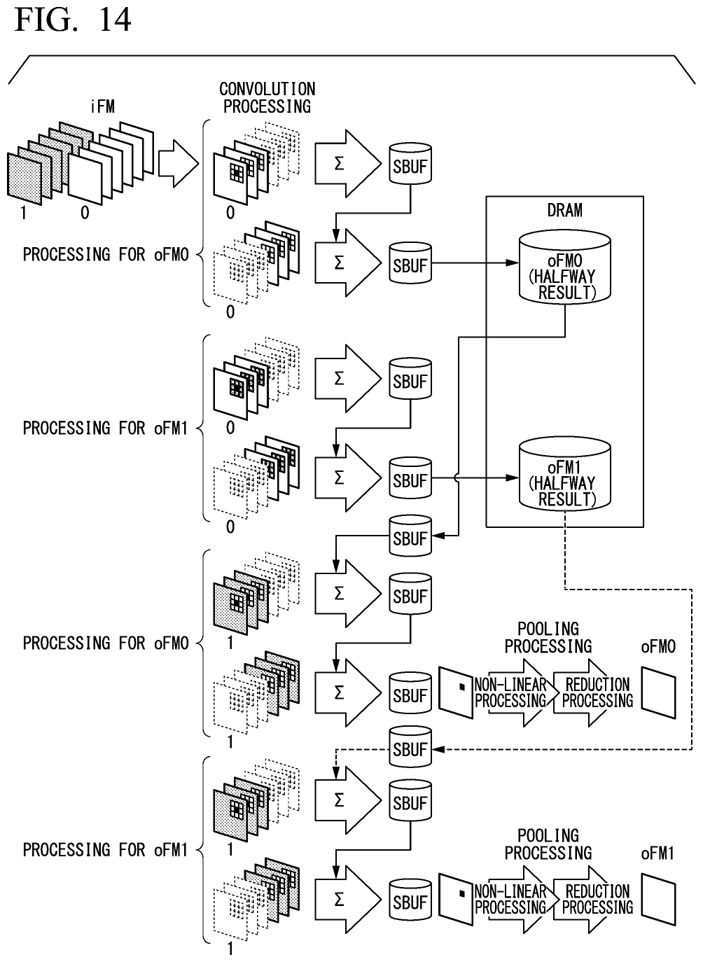

Therefore, as a fourth embodiment, a method that can cope with a increase in the number of oFMs without increasing the scale will be described. FIG. 14 is a diagram showing an image of convolution processing in the arithmetic processing device according to the present embodiment.

Also in the present embodiment, as in the first to third embodiments, an SBUF having the same (or larger) capacity as the iFM size (for one iFM) is prepared. That is, the SBUF has a size capable of storing the intermediate result of the cumulative addition for all pixels on one plane of the iFM.

In the present embodiment, the cumulative addition intermediate result generated in the middle of processing for one oFM is once written to the DRAM. This is done for m planes. When the iFM is updated and the cumulative addition is continuously performed, the output cumulative addition intermediate result is read from the DRAM and continuously processed.

The processing flow of this embodiment will be described with reference to FIG. 14. FIG. 14 shows a convolution processing image in the case of generating two oFM data (oFM0 and oFM1) as in FIG. 13.

First, for oFM0 data, each data of the first iFM group (n₁=0) is multiplied by a filter coefficient to perform cumulative addition, and the cumulative addition intermediate result is stored in the SBUF. Then, after updating the filter coefficient stored in the WBUF, cumulative addition is performed with the value of the SBUF as the initial value, and the cumulative addition intermediate result is stored in the SBUF. The cumulative addition intermediate result stored in the SBUF is sequentially transmitted to the DRAM as an intermediate result of the oFM0 data.

Next, after updating the filter coefficient stored in the WBUF for the oFM1 data, each data of the first iFM group (n₁=0) is multiplied by the filter coefficient to perform cumulative addition, and the cumulative addition intermediate result is stored in the SBUF. Then, after updating the filter coefficient stored in the WBUF, cumulative addition is performed with the value of the SBUF as the initial value, and the cumulative addition intermediate result is stored in the SBUF. The cumulative addition intermediate result stored in the SBUF is sequentially transmitted to the DRAM as an intermediate result of the oFM1 data.

Next, the second iFM group (n₁=1) is read into the IBUF. Then, for the oFM0 data, the intermediate result of the oFM0 data stored in the DRAM is stored in the SBUF as the initial attic. Next, with the value of the SBUF as the initial value, each data of the second iFM group (n₁=1) is multiplied by a filter coefficient to perform cumulative addition, and the cumulative addition intermediate result is stored in the SBUF. Then, after updating the filter coefficient stored in the WBUF, cumulative addition is performed with the value of the SBUF as the initial value, and the cumulative addition intermediate result is stored ire the SBUF. The data of oFM0 is obtained by performing pooling processing such as non-linear processing and reduction processing on the cumulative addition result obtained in this manner.

Next, after updating the filter coefficient stored in the WBUF for the oFM1 data, the intermediate result of the oFM1 data stored in the DRAM is stored in the SBUF as an initial value. Next, with the value of the SBUF as the initial value, each data of the second iFM group (n₁=1) is multiplied by a filter coefficient to perform cumulative addition, and the cumulative addition intermediate result is stored in the SBUF. Then, after updating the filter coefficient stored in the WBUF, the cumulative addition is performed with the value of the SBUF as the initial value, and the cumulative addition intermediate result is stored in the second SBUF. The data of oFM1 is obtained by performing pooling processing such as non-linear processing and reduction processing on the cumulative addition result obtained in this manner.

In this way, the data acquired from the DRAM is temporarily stored in the SBUF. Then, it will be in the same state as the previous case where the initial value is stored in the SBUF, and the processing can be started from there as before. Even at the end of the processing, non-linear processing or the like is performed before the data is output to the. DRAM.

This embodiment is disadvantageous in that the processing speed is lowered by outputting the cumulative addition intermediate result to the DRAM. However, since the processing of the present embodiment can be handled with almost no increase in the circuit, it is possible to support the latest network if some performance deterioration can be tolerated.

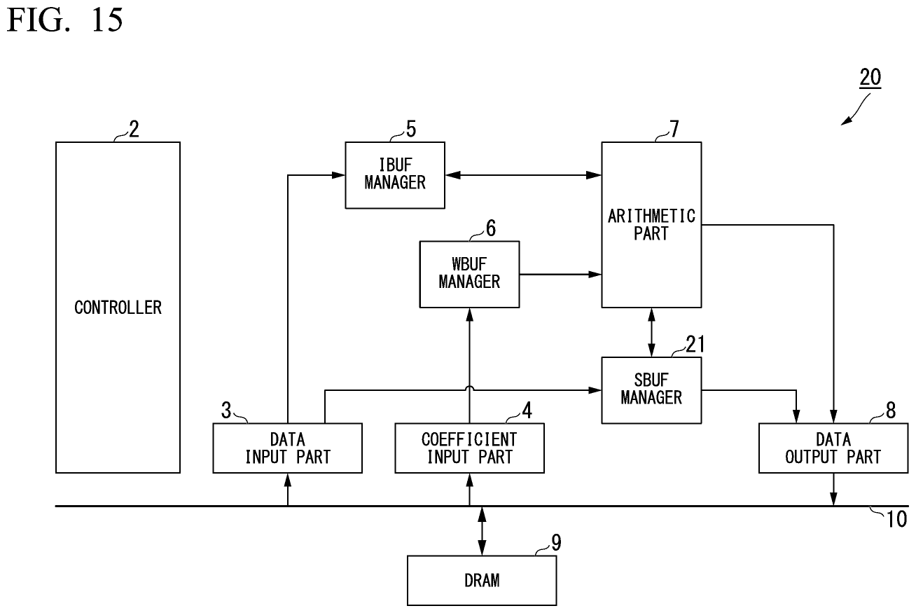

Next, a configuration for performing the processing of the present embodiment will be described. FIG. 15 is a block diagram showing the overall configuration of the arithmetic processing device according to the present embodiment. The arithmetic processing device 20 shown in FIG. 15 is different from the arithmetic processing device 1 of the first embodiment shown in FIG. 1 in the configuration of the SBUF manager.

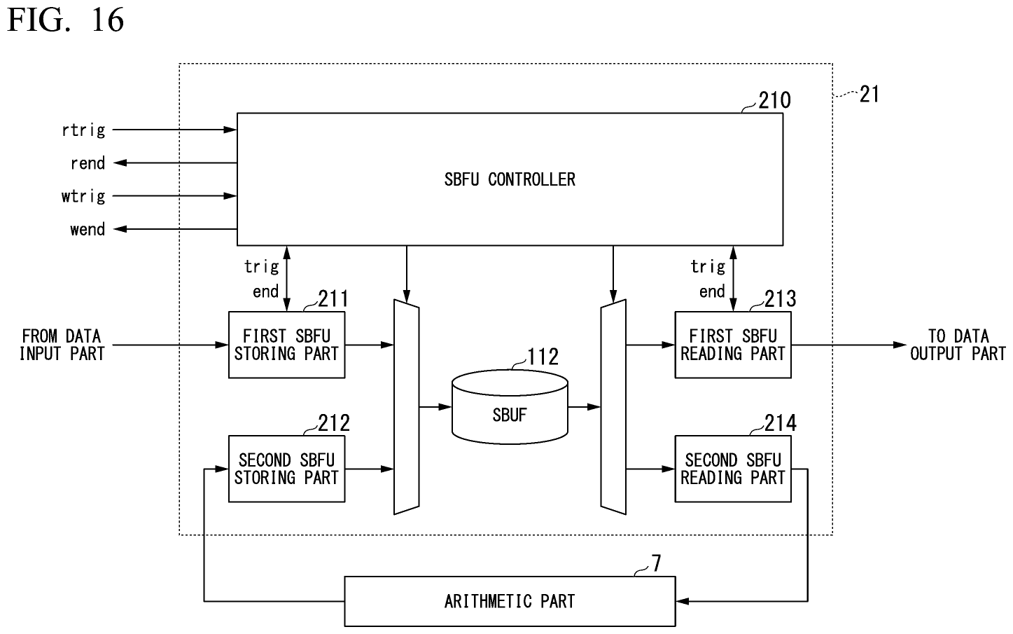

FIG. 16 is a block diagram showing the configuration of the SBUF manager 21 of the present embodiment. The SBUF manager 21 includes the SBUF controller 210, the first SBUF storing part 211, the second SBUF storing part 212, the SBUF 112, the first SBUF reading part 213, and the second SBUF reading part 214.

The SBUF 112 is a buffer for temporarily storing the intermediate result of cumulative addition in each pixel unit of iFM. The first SBUF storing part 211 and the first SBUF reading part 213 are I/F for reading and writing values to the DRAM.

When the first SBUF storing part 211 receives data (intermediate result) from the DRAM 9 via the data input part 3, it generates an address and writes it to the SBUF 112. When the second SBUF storing part 212 receives valid data (cumulative addition intermediate result) from the arithmetic, part 7, it generates an address and writes it to the SBUF 112.

The first SBUF reading part 213 reads desired data (intermediate result) from the SBUF 112 and writes it to the DRAM 9 via the data output part 8. The second SBUF reading part 214 reads desired data (cumulative addition intermediate result) from the SBUF 112 and outputs it to the arithmetic part 7 as the initial value of the cumulative. addition.

Since the configuration of the arithmetic part 7 is the same as the configuration of the arithmetic part of the first embodiment shown in FIG. 6, the description thereof will be omitted. The arithmetic part 7 acquires data from the IBUF (data-storing memory) manager 5 and filter coefficients from the WBUF (falter coefficient storing memory) manager 6, in addition, the arithmetic part 7 acquires the data (cumulative addition intermediate result) read from the SBUF 112 by the second SBUF reading part 214, and performs data processing such as filter processing, cumulative addition, non-linear calculation, and pooling processing. The data processed by the arithmetic part 7 (cumulative addition halfway result) is stored in the SBUF 112 by the second SBUF storing part 212.

The SBUF controller 210 controls the loading of the initial value (cumulative addition intermediate result) from the DRAM to the SBUF and the writing of the intermediate result from the SBUF to the DRAM. In loading the initial value from the DRAM to the SBUF, as described above, the first SBUF storing part 211 receives the data (initial value) from the DRAM 9 via the data input part 3, generates an address, and writes it to the SBUF 112.

Specifically, at the time of input from the DRAM, the SBUF controller 210 acquires data from the DRAM 9 and takes it into the SBUF 112 when a ritrig (reading trigger) is input from the upper controller 2. When the acquisition is completed, the SBUF controller 210 transmits a rend (reading end) signal to be upper controller 2 and waits for the next operation.

In writing the result from the SBUF to the DRAM, as described above, the first SBUF reading part 213 reads the desired data (intermediate result) from the SBUF 112 and writes it to the DRAM 9 via the data output part 8. Specifically, when the SBUF controller 210 outputs a wtrig (write trigger) signal to the upper controller 2 at the time of output to the DRAM, all the data in the SBUF is output to the data output part 8, and when it is completed. the SBUF controller 210 transmits a rend (reading end) signal to the upper controller and waits for the next operation.

Further, the SBUF controller 210 controls the first SBUF storing part 211, the second SBUF storing part 212, the first SBUF reading part 213, and the second SBUF reading part 214. Specifically, the SBUF controller 210 outputs a trigger signal when giving an instruction, and receives an end signal when the processing is completed.

The data input part 3 loads the cumulative addition intermediate result. (intermediate result) from the DRAM 9 at the request of the SBUF manager 21. The data output part 8 writes the cumulative addition intermediate result (intermediate result) to the DRAM 9 at the request of the SBUF manager 21.

With such a configuration, it is possible to deal with a case where both input and output are enormous FM.

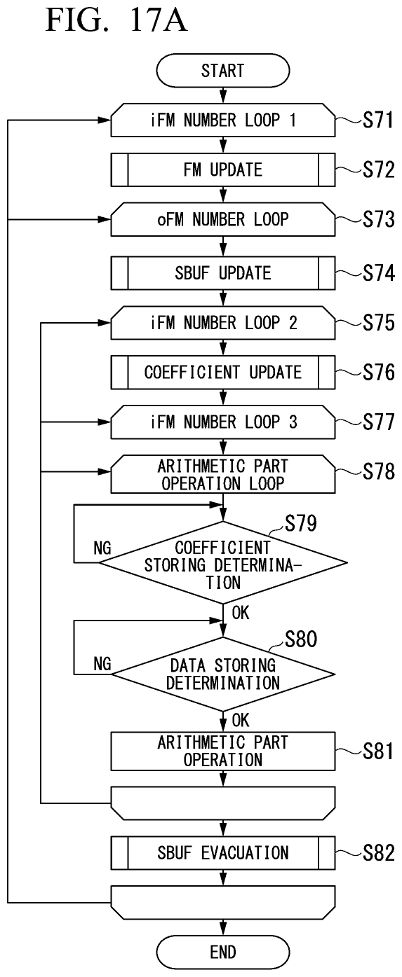

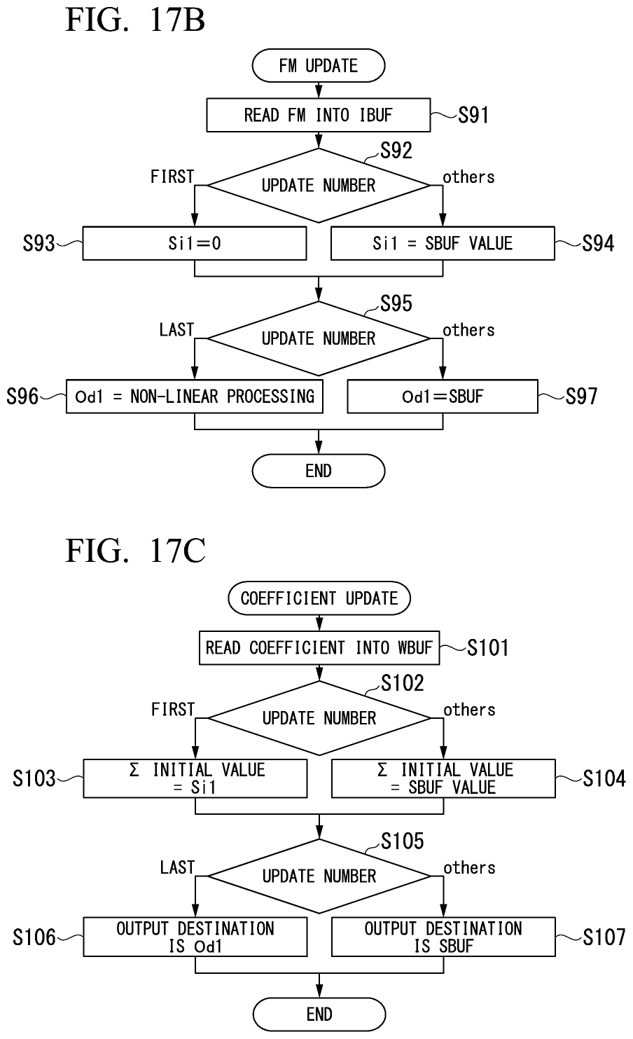

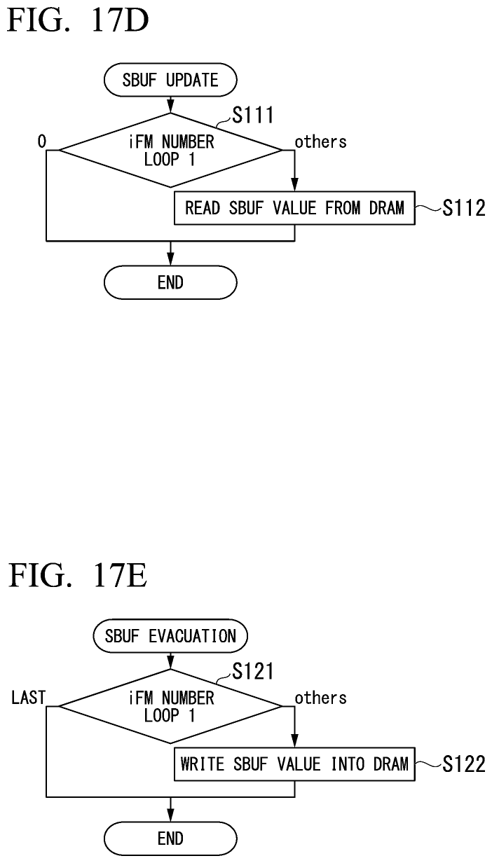

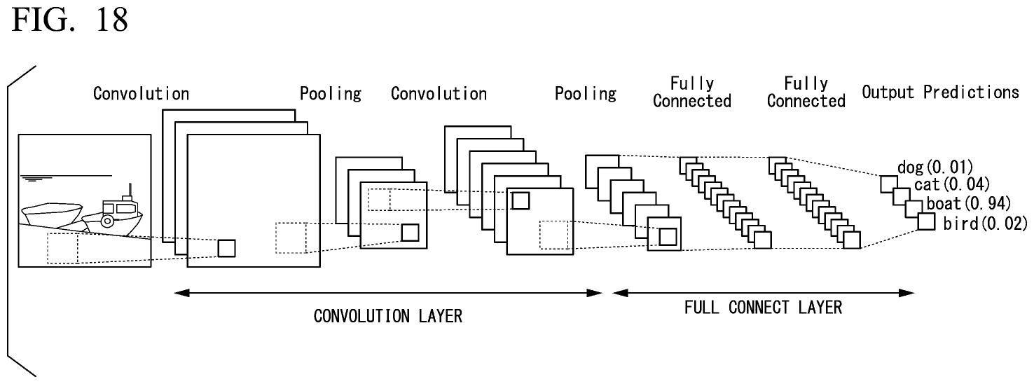

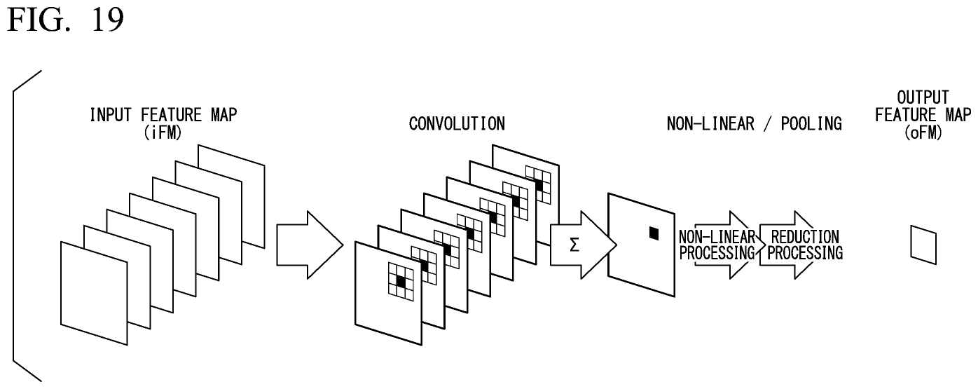

FIG. 17A is a flowchart showing the control performed by the arithmetic controller in the arithmetic processing device according to the present embodiment.

When the convolution processing is started, first, the process proceeds to the “iFM number loop 1” (step S71). Then, the iFM data stored in the IBUF is updated (step S72). Next, the process proceeds to the “oFM number loop” (step S73). Then, the data stored in the SBUF is updated (step S74). Next, the process proceeds to the “iFM number loop 2” (step S75). Then, the filter coefficient stored in the WBUF is updated (step S76). Next, the process proceeds to the “iFM number loop 3” (step S77),

Next, the process proceeds to the “arithmetic part operation loop” (step S78). Then, “coefficient storing determination” is performed (step S79). In the “coefficient storing determination”, it is determined whether or not the filter coefficient stored in the WBUF is desired. When the result of the “coefficient storing determination” is OK, the process proceeds to the “data-storing determination” (step S80). When the result of the “coefficient storing determination” is not OK, the process waits until the result of the “coefficient storing determination” is OK.

In the “data-storing determination” of step S80, it is determined whether or not the iFM data stored in the MIN is desired. When the result of the “data-storing determination” is OK, the process proceeds to the “arithmetic part operation” (step S81). When the result of the “data-storing determination” is not OK, the process waits until the result of the “data-storing determination” is OK.

In the “arithmetic part operation” of step S81, the arithmetic part performs the filter/cumulative addition processing. When the filter cumulative addition processing that can be performed on all the iFM data stored in the IBUF is completed, the process proceeds to “SBUF evacuation” (step S82). When not, the process returns to steps S75, S77, and S78, and the process is repeated.

In “SBUF evacuation” in step S82, the data stored in, the SBUF is saved in the DRAM. After that, the process returns to each step S71 and S73, the process is repeated, and the flow ends when all the calculations are completed.

FIG. 17B is a flowchart showing the flow of iFM data update control in step S72 of FIG. 17A. First, in step S91, iFM data is read into the IBUF. Then, in step S92, the number of times when the iFM data is updated is counted. When the iFM data update is the first, the process proceeds to step S93, and the value Si1 is set to zero. When the iFM data update is not the first, the process proceeds to step S94, and the value Si1 is set to the value stored in the SBUF.

Then, in step S95, the number of times when the iFM data is updated is counted. When the iFM data update is the last, the process proceeds to step S96, and Od1 is set to the non-linear processing part. When the iFM data update is not the last, the process proceeds to step S97, and Od1 is set to the SBUF.

FIG. 17C is a flowchart showing the flow of filter coefficient update control in step S76 of FIG. 17A. First, in step S101, the filter coefficient is read into the WBUF. Then, in step S102, the number of times when the filter coefficient is updated is counted. When the filter coefficient update is the first, the process proceeds to step S103, and the cumulative addition initial value is set to the value Si1. When the filter coefficient update is not the first. the process proceeds to step S104, and the cumulative addition initial value is set to the value stored in the SBUF.

Then, in step S105, the number of times when the filter coefficient is updated is counted. When the filter coefficient update is the last, the process proceeds to step S106, and the output destination of the data (cumulative addition result) is se to Od1. When the filter coefficient update is not the last, the process proceeds to step S107, and the output destination of the data (cumulative addition result) is set to SBUF.

In the iFM data update control of FIG. 17B and the filter coefficient control of FIG. 17C, the values Si1 (step S93 or 594), Od1 (step S96 or 597), the initial cumulative addition value (step S103 or 5104), and the output destination (step S106 or S107) of the data. (cumulative addition result) is transmitted to the arithmetic controller of it arithmetic part as status information, and. the arithmetic controller controls switching of each unit according to the status.

FIG. 17D is a flowchart showing the flow of SBUF update control it step S74 of 17A. In step S111, the number of iFM loops 1 is determined. When the iFM loop 1 is the first, no processing is performed (ends). When the iFM loop 1 is not the first, the process proceeds to step S112, and the SBUF value is read from the DRAM.

FIG. 17E is a flowchart showing the flow of SBUF evacuation control in step S82 of FIG. 17A. In step S121, the number of iFM loops 1 is determined. When the iFM loop 1 is the last one, no processing is performed (ends). When the iFM loop 1 is not the last, the process proceeds to step S122, and the SBUF value is written to the DRAM.

In the above-described control flow, the number of loops is set to n, which is divided as n=n₁×n₂×n₃. Here, the number of “iFM number loop 1” (step S71)=n₁, the number of “iFM number loop'” (step S75)=n₂, and the number of “iFM number loop 3” (step S77)=n₃. At this time, the cumulative addition by the second adder 74 is times the number of times when the intermediate result is once written to the SBUF is n₂ times, and the number of times when the intermediate result is written to the DRAM is n₁ times.

The control flow of FIG. 17A is based on the premise that the update frequency of the filter coefficient group is higher than the update frequency of the iFM group. In contrast, it is assumed that the update frequency of the filter coefficient group is not less than the update frequency of the iFM group. This is because if the iFM group is updated first, the iFM group must be read again when the filter coefficient is updated,

Although one embodiment of the present invention has been described above., the technical scope of the present invention is not limited to the above-described embodiment, and the combination of components can be changed, various changes can be in ide to each component, and the components cum be deleted without deputing from the spirit of the present invention.

Each component is for explaining the function and processing related to each component. One configuration (circuit) may simultaneously realize functions and processes related to a plurality of components.

Each component ma be realized by a computer including one or more processors, a logic circuit, a memory, an input output interface, a computer-readable recording medium, and the like, respectively or as a whole. In that case, the above-described various functions and processes may be realized by recording a program for realizing each component or the entire function on a recording medium, loading the recorded program into a computer system, and executing the program.

In this case, for example, the processor is at least one or a CPU, a DSP (Digital Signal Processor), and a CPU (Graphics-Processing Unit). For example, the logic circuit, is at least one of ASIC (Application-Specific Integrated Circuit) and FPGA (Field-Programmable Gate Array).

Further, the “computer system” referred to here may include hardware such as an OS and peripheral devices. Further, the “computer system” includes a homepage-providing environment (or a display environment) if a WWW system is used. The “computer-readable recording medium” includes a writable non-volatile memory such as a flexible disk, a magneto-optical disk, a ROM, and a flash memory, a portable medium such as a CD-ROM, and a storage device such as a hard disk built into a computer system.

Further, the “computer-readable recording medium” also includes those that hold the program for a certain period of time, such as a volatile memory (for example, DRAM (Dynamic Random-Access Memory)) inside a computer system that serves as a server or a client when a program is transmitted via a network such as the Internet or a communication line such as a telephone line.

Further, the program may be transmitted from a computer system in which this program is stored in a storing part device or the like to another computer system via a transmission medium or by a transmission wave in the transmission medium. Here, the “transmission medium” for transmitting a program refers to a medium having a function of transmitting information, such as a network (communication network) such as the Internet or a communication line such as a telephone line. Further, the above program may be for realizing a part of the above-described functions, Further, it may be a so-called difference rite (difference program) that realizes the above-described function in combination with a program already recorded in the computer system.

The present invention can be widely applied to an arithmetic processing device that performs deep learning using a convolutional neural network.

What is claimed is:

1. An arithmetic processing device for deep learning that performs a convolution processing and a full-connect processing, comprising:
a data-storing memory manager having a data-storing memory configured to store input feature amount map data and a data-storing memory control circuit configured to manage and control the data-storing memory;
a filter coefficient storing memory ma nagger having a filter coefficient storing memory configured to store a filter coefficient and a filter coefficient storing memory control circuit configured to manage and control the filter coefficient storing memory;
an external memory configured to store the input feature map data and output feature map data;
a data input part configured to acquire the input feature amount map data from the external memory;
a filter coefficient input part configured to acquire the filter coefficient from the external memory:,
an arithmetic part with a configuration in which N-dimensional data. is input, processed in parallel, and M-dimensional data is output (where N and M are positive numbers greater than 1), configured to acquire the input feature map data from the data-storing memory, acquire the coefficient from the coefficient storing memory, and perform a filter processing, a cumulative addition processing, a non-linear arithmetic processing, and a pooling processing;
a data output part configured to convert the M-dimensional data output from the arithmetic part to output as output feature map data to the external storing memory,
a cumulative addition result storing memory manager including
a cumulative addition result storing memory configured to temporarily record an intermediate result of cumulative addition processing for each pixel of the input feature map,
a cumulative addition result storing memory storing part configured to receive valid data, generate an address, and write it to the cumulative addition result storing memory, and
a cumulative addition result storing memory reading part configured to read specified data from the cumulative addition result storing memory, and
a controller configured to control in the arithmetic processing device,
wherein the arithmetic part includes
a filter arithmetic part configured to perform a filter arithmetic on the N-dimensional data in parallel,
a first adder configured to cumulatively add arithmetic results of the filter arithmetic part,
a second adder configured to cumulatively add cumulative addition results of the first adder in a subsequent stage,
a flip-flop configured to hold a cumulative addition result of the second adder, and
an arithmetic controller configured to control in the arithmetic part,
in a case where, during filter processing and cumulative addition processing to calculate a particular pixel in the output feature map, all input feature map data required for filter processing and cumulative addition processing cannot be stored in the data-storing memory or all filter coefficients required for filter processing and cumulative addition processing cannot be stored in the filter coefficient storing memory, the arithmetic controller controls so as to temporarily store the intermediate result in the cumulative addition result storing memory to perform a processing for another pixel, to return to a processing for a first pixel when the intermediate result of the cumulative addition processing for all pixels is stored in the cumulative addition result storing memory, to read a value stored in the cumulative addition result storing memory as an initial value of the cumulative addition processing, and to perform a continuation of the cumulative addition processing.

2. The arithmetic processing device according to claim 1, wherein
the arithmetic controller controls so as to temporarily store the intermediate result in the cumulative addition result storing memory when all filter processing and cumulative addition processing that can be performed with all filter coefficients stored in the filter coefficient storing memory are completed, and
to perform a continuation of the cumulative addition processing when the filter coefficient stored in the filter coefficient storing memory is updated.

3. The arithmetic processing device according to claim 1, wherein.
the arithmetic controller controls so as to temporarily store the intermediate result in the cumulative addition result storing memory when all filter processing and cumulative addition processing that are capable of being performed on all input feature amount map data that is capable of being input, and
to perform a continuation of the cumulative addition processing when the input feature amount map data stored in the data-storing memory is updated.

4. The arithmetic processing device according to claim 1, wherein
the cumulative addition result storing memory manager includes
a cumulative addition result storing memory reading part configured to read a cumulative addition intermediate result from the cumulative addition result storing memory and writes it to the external memory, and
a cumulative addition result storing memory storing part configured to read the cumulative addition intermediate result from the external memory and stores it in the cumulative addition result storing memory,
wherein the arithmetic controller controls so as to read the intermediate result from the cumulative addition result Storing memory to write into the external memory during the filter processing and the cumulative addition processing for calculating a specific pixel of the output feature amount map, and
to read the cumulative addition intermediate result written to the external memory from the external memory to write into the cumulative addition result storing memory, and perform a continuation of the cumulative addition processing when the input feature amount map data stored in the data-storing memory or the filter coefficient stored in the filter coefficient storing memory is updated and the cumulative addition processing is continuously performed.
